(19) United States
(12) Patent Application Publication
(10) Pub. No.: US 2005/0066998 A1
(43) Pub. Date: Mar. 31, 2005

(54) Dishwasher with kinetic energy water distribution system

(75) Inventors: Mark E. Palm, Jackson, TN (US); Michael J. Kramer, Jackson, TN (US); Kristen K. Hedstrom, Humboldt, TN (US)

Correspondence Address: MCKEE, VOORHEES & SEASE, P.L.C.;ATTN: MAYTAG, 801 GRAND AVENUE, SUITE 3200, DES MOINES, IA, 50309-2721, US

(73) Assignee: MAYTAG CORPORATION, NEWTON, IA (US)

(21) Appl. No.: 10/671,370

(22) Filed: Sep. 25, 2003

(51) Int. Cl. B08B 3/02

(52) U.S. Cl. 134/10; 134/25.2; 134/34; 134/198; 134/200; 134/184

(57) ABSTRACT

An improved water distribution system is provided for a dishwasher. The system includes one or more disks mounted in the dishwasher for rotation about a vertical axis, and one or more water nozzles in the dishwasher for directing a water jet onto the disks. The water jets are directed transverse to the axis of rotation of the disks so as to impart rotation to the disks, and thereby redirect the water jet to a radial direction for distribution in the washing chamber of the dishwasher. Thus, the linear kinetic energy of the water jet is transferred to radial kinetic energy by the rotating disk.

### BACKGROUND OF THE INVENTION

Dishwashers typically include upper and lower rotatable spray arms operatively connected to a water manifold to distribute water within the washing chamber for cleaning the objects in the dishwasher racks. These conventional spray arm water distribution systems are relatively complex in construction, with moving parts and precise connections. Such complexity increases the manufacturing costs, and thus the cost to the consumer.

Accordingly, a primary objective of the present invention is a simplified water distribution system for dishwashers.

Another objective of the present invention is the provision of a dishwasher having a kinetic energy water distribution system.

A further objective of the present invention is the provision of a dishwasher which directs a water jet with linear kinetic energy onto a disk which distributes the water jet with radial kinetic energy.

Yet another objective of the present invention is the provision of a method of distributing water in a dishwasher by transferring linear kinetic energy of a water jet into radial kinetic energy.

Another objective of the present invention is the provision of a method of distributing water in a wash chamber wherein a water jet is directed in a linear path onto a rotating disk for redirecting the water in to a radial direction, with the linear and radial directions being co-planer.

A further objective of the present invention is the provision of an improved method of distributing water in a dishwasher using a horizontal jet of water.

Another objective of the present invention is the provision of an improved dishwasher which is economical to manufacture and durable and efficient in use.

These and other objectives will become apparent from the following description of the invention.

### SUMMARY OF THE INVENTION

The dishwasher of the present invention includes a washing chamber defined by opposite side walls, a bottom wall, a top wall, a back wall, and a door. A disk is mounted in the top wall for rotation about a vertical axis and includes a plurality of vanes. A water nozzle is provided on the back wall of the chamber to direct a water jet horizontally onto the vanes of the disk so as to rotate the disk and thereby redirect the water radially for distribution in the wash chamber. Accordingly, the initial linear kinetic energy of the water jet is converted to radial kinetic energy upon impact with the disk. The water jet is directed substantially horizontally from the nozzle onto the disk, so as to be substantially perpendicular to the rotational axis of the disk. Accordingly, the linear and radial kinetic energies reside in a common plane.

### BRIEF DESCRIPTION OF THE DRAWINGS

FIG. 1 is a perspective view of a dishwasher mounted under a kitchen counter, with the door open and having a pair of racks positioned in the washing chamber.

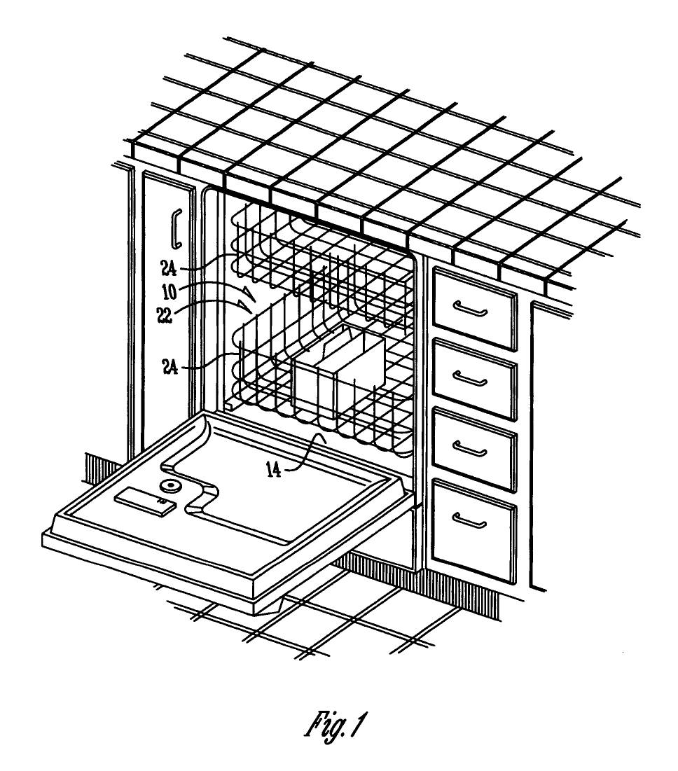

FIG. 2 is a perspective view showing the dishwasher with a portion of the top wall broken out to show the water distribution system of the present invention.

FIG. 3 is a view similar to FIG. 2 showing a water distribution system utilizing a pair of water nozzles and a pair of rotating disks in accordance with an alternative embodiment of the present invention.

FIG. 4 is a perspective view of a drawer-style dishwasher having the water distribution system of the present invention.

### DETAILED DESCRIPTION OF THE DRAWINGS

The dishwasher of the present invention is generally designated by the reference numeral 10 in the drawings. The dishwasher 10 includes opposite sidewalls 12, a bottom wall 14, a top wall 16, a back wall 18, and a door 20. The walls 12, 14, 16, 18 and the door 20 define a washing chamber 22 in which racks 24 are positioned for washing objects in the racks 24.

The above description of the dishwasher 10 is conventional, and does not form part of the present invention.

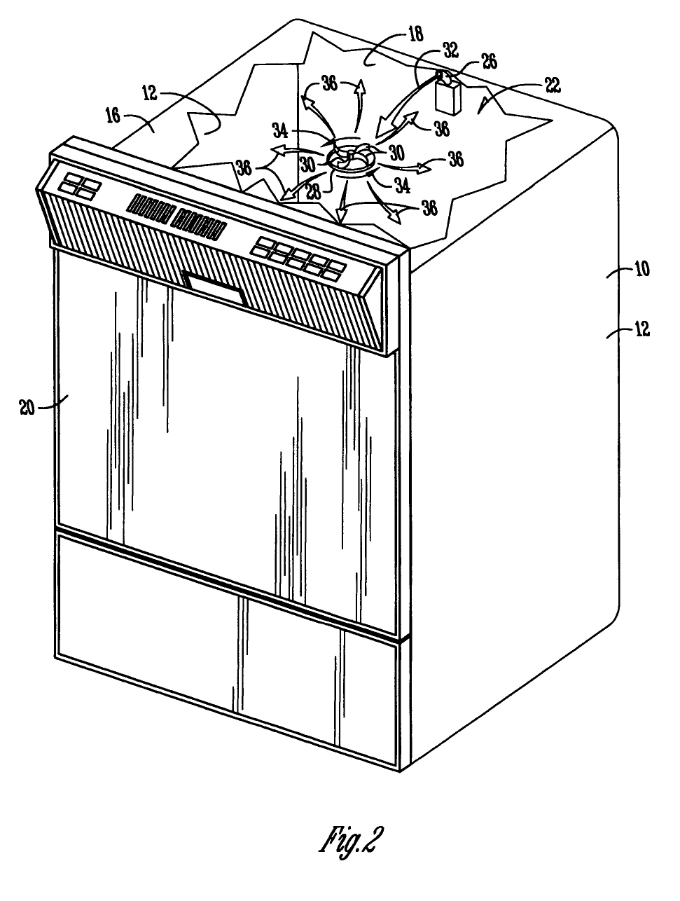

The present invention is directed towards the water distribution system for the dishwasher 10. More particularly, the water distribution system includes a water nozzle 26 mounted in the back wall 18 adjacent the top wall 16, as seen in FIG. 2. A disk 28 is mounted in the top wall 16 for rotation about a vertical axis. The disk 28 includes a plurality of vanes 30.

In operation, a water jet is emitted from the water nozzle 26 in a substantially horizontal direction, as indicated by arrow 32, so as to have linear kinetic energy. The water jet impinges upon the vanes 30 of the disk 28, thereby rotating the disk 28, as indicated by the arrows 34. The rotation of the disk 28 redirects the water jet in a radial pattern, as indicated by arrows 36, such that the water is distributed throughout the chamber 22. Thus, the linear kinetic energy of the water jet is transferred to radial kinetic energy by the rotating disk 28. The linear and radial kinetic energies are substantially co-planer, since the water jet is directed substantially perpendicular to the rotational axis of the disk 28.

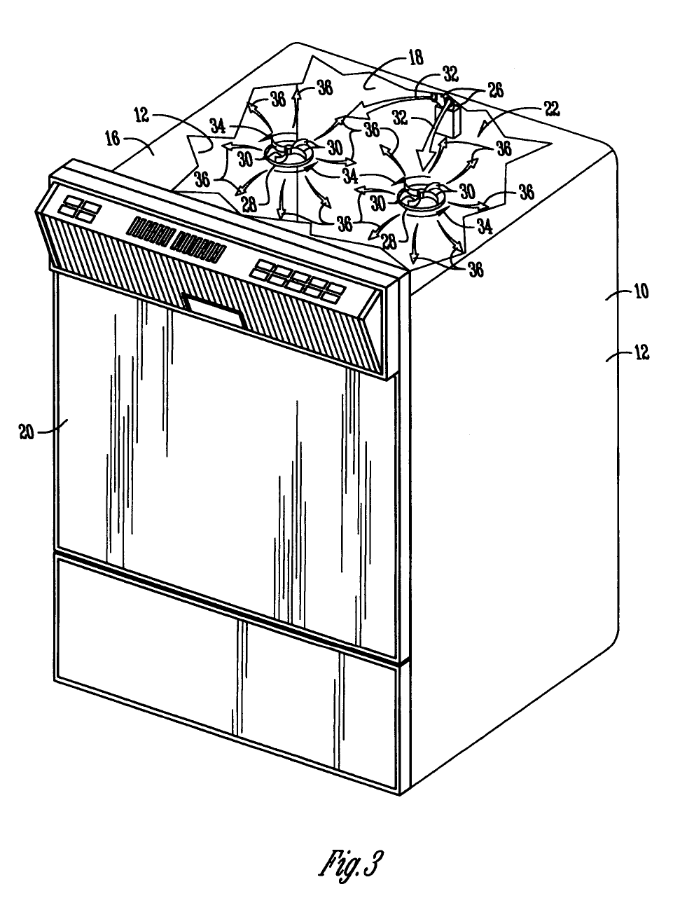

FIG. 3 shows an alternative embodiment of the present invention wherein a pair of water nozzles 46, 47 are provided on the back wall 18 for directing two water jets onto a pair of rotatable disks 28 mounted in the top wall 16. Each nozzle 26 directs a water jet to one of the disks 28, as indicated by the arrows 32, with the disks rotating in the direction shown by arrows 34 so as to transfer the linear water flow to a radial flow as indicated by arrows 36, for distribution of the water onto objects contained in the racks 28.

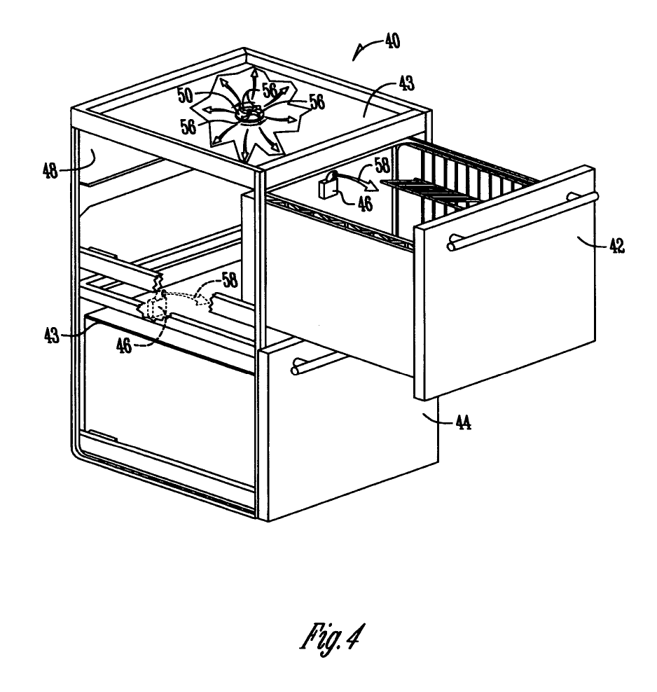

FIG. 4 shows a perspective view of a drawer-style dishwasher 40 with an upper drawer 42 and a lower drawer 44. Each drawer 42, 44 includes racks for holding dishes and other objects to be washed. Each drawer 42, 44 is adapted to move between an open position when the drawer is pulled out, a seen with drawer 42 in FIG. 4, and a closed position when the drawer is pushed in. The drawers 42, 44 seal with a lid or cover 43 when pushed in to the closed position. The structure of the drawers 42, 44 and the racks therein are conventional.

In the drawer-style dishwasher 40, a water nozzle 46 is mounted on the rear wall 48 of each drawer 42, 44. A disk 50 is mounted on the bottom of each lid 43 for rotation about a vertical axis. Each disk 50 includes a plurality of veins 56. Alternatively, a pair of water nozzles 46 and a pair of disks 50 may be provided for each drawer 42, 44, similar to FIG. 3.

In operation, the upper water nozzle 46 directs a water jet in a substantially horizontal direction, as indicated by arrow 58, so as to have linear kinetic energy. The water jet impinges upon the veins 56 of the disk 50, thereby rotating the disk 50 to redirect the water jet in a radial pattern, such that the water is distributed throughout the chamber of the drawers 42, 44. Thus, the water distribution system of the dishwasher 40 functions in the same manner as the water distribution system for the dishwasher 10.

Each of the illustrated and described dishwashers show the water nozzles mounted on the back wall. It would also be equally feasible to mount the water nozzles to one of the side walls or even to the top wall of the dishwasher.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

1. A dishwasher, comprising:
a washing chamber defined by opposite side walls, a bottom wall, a top wall, a back wall, and a door;
a disk mounted on the top wall for rotation about a vertical axis and having a plurality of vanes;
a water nozzle on one of the back wall, side walls, or top wall to direct a water jet horizontally onto the vanes of the disk to rotate the disk and thereby redirect the water radially for distribution in the washing chamber.

2. The dishwasher of claim 1 further comprising a second disk with vanes mounted in the top wall for rotation about a vertical axis and a second water nozzle to direct a second water jet horizontally onto the vanes of the second disk to rotate the second disk and thereby redirect the water radially for distribution in the washing chamber.

3. The dishwasher of claim 1 wherein the disk is adjacent the top wall, and the water nozzle is adjacent the top wall.

4. An improved water distribution system for a dishwasher, comprising:
a rotatable disk in the dishwasher;
a water nozzle in the dishwasher;
the water nozzle adapted to direct a water jet toward the disk in a direction transverse to an axis of rotation of the disk so as to impart rotation to the disk and thereby redirect the water jet in a radial spray pattern in the dishwasher.

5. The improved water distribution system of claim 4 further comprising at least a second rotatable disk in the dishwasher, and at least a second nozzle in the dishwasher to direct a second water jet at the second disk so as to impart rotation to the second disk and thereby redirect the water jet to a radial spray pattern in the dishwasher.

6. The improved water distribution system of claim 4 wherein the disk has a plurality of vanes upon which the water jet impacts.

7. The improved water distribution system of claim 4 wherein the disk has a generally vertical axis of rotation.

8. A method of distributing water in a dishwasher, comprising:
providing a water jet with linear kinetic energy;
transferring the linear kinetic energy into radial kinetic energy to distribute water in the dishwasher; and
the linear and radial kinetic energies being in a common plane.

9. The method of claim 8 wherein the water jet is directed onto a rotatable disk.

10. The method of claim 9 wherein the water jet is directed in a path substantially perpendicular to an axis of rotation of the disk.

11. The method of claim 8 wherein the linear kinetic energy is directed substantially horizontally.

12. A method of distributing water in a wash chamber, comprising:
directing a water jet in a linear path onto a disk in the chamber so as to rotate the disk about an axis,
redirecting the water jet in a radial direction from the disk; and
the linear path being substantially perpendicular to the axis of the rotation of disk.

13. The method of claim 12 wherein the linear path is substantially horizontal and the disk axis is substantially vertical.
